(19) United States
(12) Patent Application Publication
(10) Pub. No.: US 2009/0060491 A1
(43) Pub. Date: Mar. 5, 2009

(54) Diaphragm-shutter mechanism, controlling method thereof, and camera using the same

(76) Inventor: Wei-Chen Chih, Hukou Township (TW)

Correspondence Address: HDLS Patent & Trademark Services, P.O. BOX 220746, CHANTILLY, VA, 20153-0746, US

(21) Appl. No.: 11/874,990

(22) Filed: Oct. 19, 2007

(30) Foreign Application Priority Data
Sep. 5, 2007 (TW) 096133129

(51) Int. Cl. G03B 9/08

(52) U.S. Cl. 396/449

(57) ABSTRACT

A photosensitive electronic diaphragm-shutter mechanism includes a diaphragm-shutter unit and a control unit. The diaphragm-shutter unit includes a first photosensitive electronic member and a second photosensitive electronic member, which are overlapped to be positioned. The control unit outputs signals to the first photosensitive electronic member and the second photosensitive electronic member respectively for controlling the transparent status or non-transparent status thereof. The time difference of the first photosensitive electronic member and the second photosensitive electronic member when transferring status decides a shutter time. The present invention also provides a controlling method for photosensitive electronic diaphragm-shutter mechanism.

### BACKGROUND OF THE INVENTION

1. Field of Invention

The present invention relates to a diaphragm-shutter mechanism, especially relates to a photosensitive electronic diaphragm-shutter mechanism, a controlling method thereof and a camera using the same.

2. Description of Related Art

Generally, a conventional camera and a fashionable digital camera both include a mechanical diaphragm-shutter mechanism. The mechanical diaphragm-shutter mechanism used in cameras changes little till today.

The conventional mechanical diaphragm-shutter mechanism is commonly consisted of several convex lenses and concave lenses to adjust the quantity of light passing through the diaphragm-shutter using optical reflection or optical refraction. Massive module, complex assembling, heaviness and occupying large space are the disadvantages of the conventional mechanical diaphragm-shutter mechanism and make it far away from the tendency that camera becomes lighter and handier.

If taking the automatic focus device of a conventional camera as an example, a motor is needed to drive at least five convex lenses and concave lenses, which make the weight of the lens module occupying 50% to 60% of the weight of the camera. Thus, the camera is not convenient to be used because of complex assembling, its heaviness, and requiring an additional power supply to support the additional power consumption.

An improved diaphragm-shutter mechanism is a photosensitive electronic diaphragm-shutter mechanism using photosensitive electronic material. The photosensitive electronic diaphragm-shutter mechanism applies an electric field to control light and shade status of the photosensitive electronic material and further to control the exposal time and the quantity of light to accomplish a function of the shutter.

The improved photosensitive electronic diaphragm-shutter mechanism can simplify its structure and assembling process. However, when the light and shade status of the photosensitive electronic material are controlled by the electric field, because of the electronical signal transmission and actions of the photosensitive electronic material all have delay phenomena, the photosensitive electronic diaphragm-shutter mechanism will delay a response time. The response time (about 2 ms) limits the fastest speed of the diaphragm-shutter mechanism, resulting in blurry pictures when taking photos for a moving object.

What is needed is a photosensitive electronic diaphragm-shutter mechanism with a fast shutter speed.

### SUMMARY OF THE INVENTION

One object of the invention is to provide a photosensitive electronic diaphragm-shutter mechanism with a fast shutter speed.

Another object of the invention is to provide a camera using the above photosensitive electronic diaphragm-shutter mechanism.

The invention provides a photosensitive electronic diaphragm-shutter mechanism. The photosensitive electronic diaphragm-shutter mechanism includes a control unit and a diaphragm-shutter unit. The diaphragm-shutter unit includes a first photosensitive electronic member and a second photosensitive electronic member both of which are controlled by an electric field to be on transparent status or non-transparent status. The control unit outputs electronical signals to the first photosensitive electronic member and the second photosensitive electronic member respectively for controlling transfers between the transparent status and non-transparent status thereof, and for controlling the time difference of the first photosensitive electronic member and the second photosensitive electronic member when transferring status to decide a shutter time.

The invention also provides a method of controlling a photosensitive electronic diaphragm-shutter mechanism. The photosensitive electronic diaphragm-shutter mechanism includes a control unit, an operation unit and a diaphragm-shutter unit. The operation unit and the diaphragm-shutter unit are electronically connected to the control unit, and the diaphragm-shutter unit includes a first photosensitive electronic member and a second photosensitive electronic member overlapped with each other. The method includes setting the first photosensitive electronic member on a first status and the second photosensitive electronic member on a second status; the control unit outputting a control signal to transfer the first photosensitive electronic member to be on the second status from the first status when the operation unit is started; the control unit outputting another control signal to transfer the second photosensitive electronic member to be on the first status from the second status, wherein the time difference of the first photosensitive electronic member and the second photosensitive electronic member when transferring status decides a shutter time for light passing through the diaphragm-shutter unit.

According to the invention, the photosensitive electronic diaphragm-shutter mechanism includes a first photosensitive electronic member and a second photosensitive electronic member, which are overlapped to be positioned. The shutter time is determined by the time difference of the first photosensitive electronic member transfers status and the second photosensitive electronic member when transferring status. Thus the shutter time can be adjusted to short enough to break through the limit of the response time of the photosensitive material.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a photosensitive electronic diaphragm-shutter mechanism according to the invention.

FIG. 2 is a sequence operation diagram of the diaphragm-shutter unit 15 according to the first embodiment of the invention.

FIG. 3 is a sequence operation diagram of the diaphragm-shutter unit 15 according to the second embodiment of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

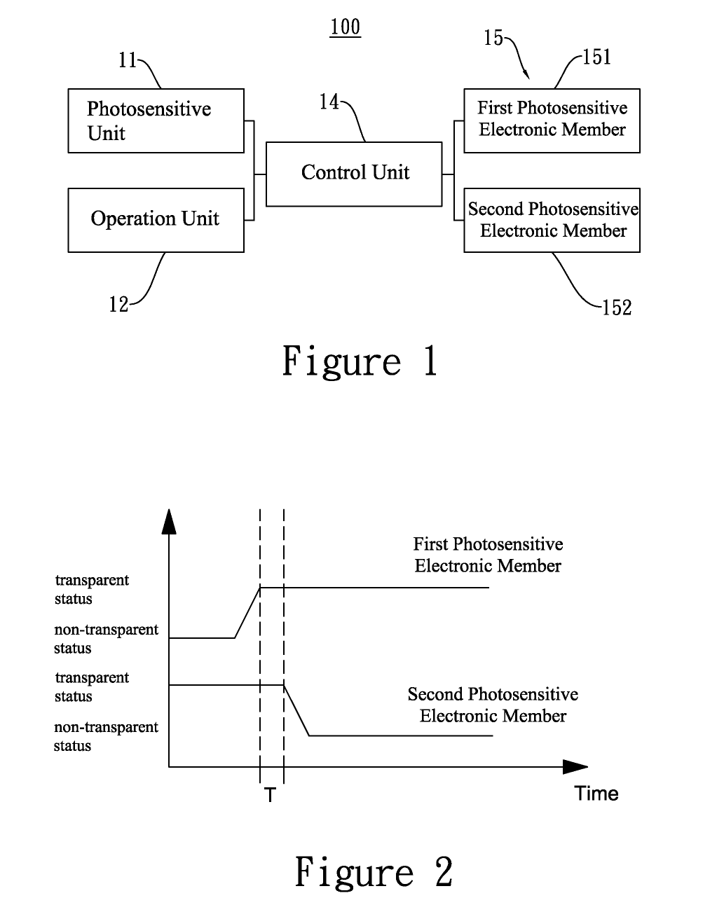

FIG. 1 is a schematic diagram of a photosensitive electronic diaphragm-shutter mechanism according to the invention. The photosensitive electronic diaphragm-shutter mechanism 100 includes a photosensitive unit 11, an operation unit 12, a control unit 14 and a diaphragm-shutter unit 15. The photosensitive unit 11 and the operation unit 12 are electrically connected to the control unit 14. The control unit 14 is electrically connected to the diaphragm-shutter unit 15. The photosensitive unit 11 is utilized to measure the quantity of the light passing through the camera lens (not shown) and outputs a corresponding electronic signal to the control unit 14. The operation unit 12 is utilized to sense a manual operation or an auto-operation, and then to send a signal to the control unit 14 for controlling the diaphragm-shutter unit 15 to perform a corresponding operation. The operation unit 12 may be a shutter key of the camera.

The diaphragm-shutter unit 15 includes a first photosensitive electronic member 151 and a second photosensitive electronic member 152, which are overlapped to be positioned and consisted of films made of photosensitive electric material. The photosensitive electric material could be a liquid crystal, chromium electroplating film, and so on. The first photosensitive electronic member 151 and the second photosensitive electronic member 152 are transparent so that light can pass through them. But when an electric field is applied on, the first photosensitive electronic member 151 and the second photosensitive electronic member 152 will be non-transparent status, and light can't pass through them. Therefore, the first photosensitive electronic member 151 and the second photosensitive electronic member 152 are utilized to control light flux and light transmittance.

The operation process of the diaphragm-shutter unit 15 is described as below.

FIG. 2 is a sequence operation diagram of the diaphragm-shutter unit 15 according to the first embodiment of the invention. Before the shutter key of the camera is pressed, the first photosensitive electronic member 151 is on non-transparent status with an electric field while the second photosensitive electronic member 152 is on transparent status. When the shutter key is pressed, the control unit 14 generates a control signal to transfer the first photosensitive electronic member 151 to be on transparent status. After a predetermined time the control unit 14 generates another control signal to apply a voltage on the second photosensitive electronic member 152 and transfer it to be on non-transparent status. Because before the second photosensitive electronic member 152 turns to be on completely non-transparent status the first photosensitive electronic member 151 is on transparent status, the first photosensitive electronic member 151 and the second photosensitive electronic member 152 both are on transparent status in a time difference T and the sensitization member (not shown) of the camera can receive the light reflected from the sensing object. Therefore, the shutter time of the diaphragm-shutter unit 15 can be adjusted by controlling the transparent status or non-transparent status of the first photosensitive electronic member 151 and the second photosensitive electronic member 152. The shutter time can be adjusted to be short enough to capture a fast moving object.

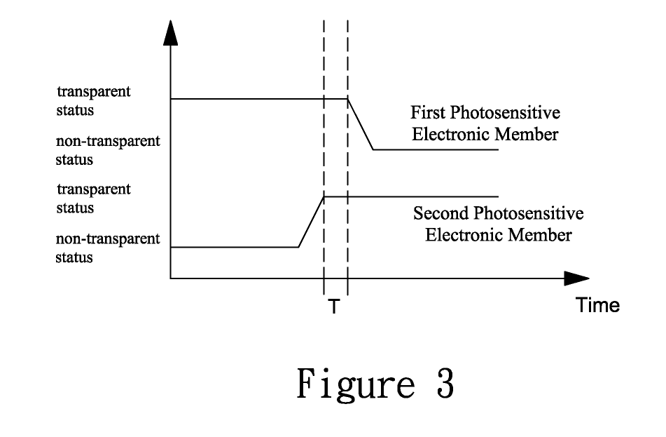

FIG. 3 is a sequence operation diagram of the diaphragm-shutter unit 15 according to the second embodiment of the invention. Before pressing the shutter key of the camera, the first photosensitive electronic member 151 is on transparent status while the second photosensitive electronic member 152 is on non-transparent status with an electric field. When the shutter key is pressed, the control unit 14 generates a control signal to transfer the second photosensitive electronic member 152 to be on transparent status. After a predetermined time the control unit 14 generates another control signal to apply a voltage on the first photosensitive electronic member 151 and transfer it to be on non-transparent status. Because before the first photosensitive electronic member 151 turns to be on completely non-transparent status the second photosensitive electronic member 152 is on transparent status, the first photosensitive electronic member 151 and the second photosensitive electronic member 152 both are on transparent status in a time difference T and the sensitization member (not shown) of the camera can receive the light reflected from the sensing object. So the shutter time can be adjusted to be short enough to capture a fast moving object.

With reference to FIG. 1 again, the operation process of the photosensitive electronic diaphragm-shutter mechanism 100 is described as below. Firstly, the photosensitive unit 11 measures the quantity of the light passing through the camera lens (not shown) and outputs a corresponding electronic signal to the control unit 14. The control unit 14 determines when and how the first photosensitive electronic member 151 and the second photosensitive electronic member 152 transfer status according to the electronic signal to decide a shutter time. The time difference T of the first photosensitive electronic member 151 and the second photosensitive electronic member 152 when transferring status is the shutter time. Then the operation unit 12 sends a signal to the control unit 14 to start the first photosensitive electronic member 151 and the second photosensitive electronic member 152 working as a diaphragm-shutter of a camera.

According to the invention, the photosensitive electronic diaphragm-shutter mechanism 100 includes a first photosensitive electronic member 151 and a second photosensitive electronic member 152, and the first photosensitive electronic member 151 and the second photosensitive electronic member 152 are overlapped with each other. The shutter time is determined by the time difference of the first photosensitive electronic member 151 and the second photosensitive electronic member 152 when transferring status. Thus the shutter time can be adjusted to short enough to break through the limit of the response time of the photosensitive material.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A photosensitive electronic diaphragm-shutter mechanism, comprising:
a control unit; and
a diaphragm-shutter unit, comprising a first photosensitive electronic member and a second photosensitive electronic member which are controlled by an electric field to be on transparent status or non-transparent status,
wherein the control unit outputs electronical signals to the first photosensitive electronic member and the second photosensitive electronic member respectively for controlling transfers between the transparent status and non-transparent status thereof, and for controlling a time difference of the first photosensitive electronic member and the second photosensitive electronic member when transferring status to decide a shutter time.

2. The photosensitive electronic diaphragm-shutter mechanism of claim 1, wherein the first photosensitive electronic member and the second photosensitive electronic member are overlapped with each other.

3. The photosensitive electronic diaphragm-shutter mechanism of claim 1, wherein the first photosensitive electronic member and the second photosensitive electronic member are films made of photosensitive electronic material.

4. The photosensitive electronic diaphragm-shutter mechanism of claim 3, wherein the photosensitive electronic material is a liquid crystal or chromium electroplating film.

5. The photosensitive electronic diaphragm-shutter mechanism of claim 1, further comprising a photosensitive unit electronically connected with the control unit, and for measuring the quantity of light.

6. The photosensitive electronic diaphragm-shutter mechanism of claim 1, further comprising an operation unit for sensing a manual operation or an auto-operation to control the control unit to drive the diaphragm-shutter unit.

7. A camera, comprising a camera lens and a photosensitive electronic diaphragm-shutter mechanism, the diaphragm-shutter comprising:
control unit; and
a diaphragm-shutter unit, comprising a first photosensitive electronic member and a second photosensitive electronic member which are controlled by an electric field to be on transparent status or non-transparent status,
wherein the control unit outputs electronical signals to the first photosensitive electronic member and the second photosensitive electronic member respectively for controlling transfers between the transparent status and non-transparent status thereof, and for controlling a time difference of the first photosensitive electronic member and the second photosensitive electronic member when transferring status to decide a shutter time.

8. A method of controlling a photosensitive electronic diaphragm-shutter mechanism, the photosensitive electronic diaphragm-shutter mechanism comprising a control unit, an operation unit and a diaphragm-shutter unit, wherein the operation unit and the diaphragm-shutter unit are electronically connected to the control unit, and the diaphragm-shutter unit comprises a first photosensitive electronic member and a second photosensitive electronic member overlapped with each other, the method comprising:
setting the first photosensitive electronic member on a first status and the second photosensitive electronic member on a second status;
the control unit outputting a control signal to transfer the first photosensitive electronic member to be on the second status from the first status when the operation unit is started;
the control unit outputting another control signal to transfer the second photosensitive electronic member to be on the first status from the second status, wherein the time difference of the first photosensitive electronic member and the second photosensitive electronic member when transferring status decides a shutter time for light passing through the diaphragm-shutter unit.

9. The method of claim 8, wherein the first photosensitive electronic member and the second photosensitive electronic member are films made of photosensitive electronic material.

10. The method of claim 8, wherein the first status is non-transparent status and the second status is transparent status.

11. The method of claim 8, wherein the first status is transparent status and the second status is non-transparent status.

12. The method of claim 8, the operation unit is a shutter key of a camera and is started by pressing the shutter key.
